(19) United States
(12) Patent Application Publication
(10) Pub. No.: US 2017/0104212 A1
(43) Pub. Date: Apr. 13, 2017

(54) Compositions for High Energy Electrodes and Methods of Making and Use

(71) Applicant: Wildcat Discovery Technologies, Inc., San Diego, CA (US)

(72) Inventors: Wei Tong, Albany, CA (US); Bin Li, San Diego, CA (US); Jen-Hsien Yang, San Diego, CA (US)

(73) Assignees: Wildcat Discovery Technologies, Inc., San Diego, CA (US); Tianjin B&M Science and Technology Joint-Stock Co., Ltd., Tianjin (CN)

(21) Appl. No.: 14/881,145

(22) Filed: Oct. 12, 2015

(51) Int. Cl. H01M 4/485; H01M 4/525; H01M 4/505

(52) U.S. Cl. CPC H01M 4/485; H01M 4/505; H01M 4/525

(57) ABSTRACT

A material for forming an electrode represented by the formula:

Li₁₊ₓ₋ₐD1ₐNm_{1-x-y-z-b1}Ni_{y-b2}D2_{b}Co _{z-b3}O_{2-δ}

where 0<a≦0.2, 0<b≦0.2,b1+b2+b3=b, 0.1≦x≦0.5, 0≦y<1, 0≦z≦0.5, and 0≦δ≦0.3 and D1 includes sodium (Na) and D2 includes yttrium (Y).

### BACKGROUND OF THE INVENTION

The present invention is in the field of battery technology and, more particularly, in the area of improved active materials for use in electrodes in electrochemical cells.

Research into active materials for cathodes for secondary batteries has yielded several classes of active materials. One class of active materials is a type of “over-lithiated” layered oxide (OLO), which can be represented by formula (i):

xLi₂MnO₃*(1−x)Li[MnᵢTM1ⱼTM2ₖ]O₂ (i)

where 0<x<1, i+j+k=1, and i is non-zero but j and/or k can be zero and TM1 and TM2 represent transition metals. Ni and Co are often the transition metals used in OLO materials. Such materials are promising candidates for next generation batteries because of their high discharge capacity (about 280 mAh/g) and energy density (about 1000 Wh/kg), which values are about double those of conventional materials for lithium ion batteries

Doping has been disclosed as one approach to improve performance in OLO materials in several patents or publications. For example, U.S. Publication 2013/0216701 discloses that “fluorine is a dopant that can contribute to cycling stability as well as improved safety” lithium rich layered oxide materials. U.S. Publication 2013/0216701 discloses single doping with sodium or potassium in a lithium rich material. U.S. Publication 2014/0057163, U.S. Publication 2014/0054493, and U.S. Pat. No. 7,678,503 disclose myriad possible dopants in a lithium rich material, but have limited disclosure on the site selection for such dopants. U.S. Publication 2014/0038056 discloses sodium doping in a lithium site and on a transition metal site of a lithium rich material.

Certain electrochemical performance challenges of over-lithiated (or lithium-rich) layered oxide materials are addressed by the embodiments disclosed herein.

### BRIEF SUMMARY OF THE INVENTION

Certain embodiments of the invention include an electrode formed from a material represented by

Li₁₊ₓ₋ₐD1ₐMn_{1-x-y-z-b1}Ni_{y-b2}D2_{b}Co_{z-b3}O_{2-δ}

where 0<a≦0.2, 0<b≦0.2, b1+b2+b3=b, 0.1≦x≦0.5, 0≦y<1, 0 ≦z≦0.5, and 0≦6≦0.3. According to some embodiments Dl includes sodium (Na) and D2 includes yttrium (Y). According to some embodiments, the material comprises Li_{1.07}Mn_{0.52}Ni_{0.2}Co_{0.1}Na_{0.1}Y_{0.01}O₂. According to some embodiments, the material comprises Li_{1.07}Mn_{0.52}Ni_{0.19}Co_{0.1}Na_{0.1}Y_{0.02}O₂. According to some embodiments, the material comprises Li_{1.07}Mn_{0.53}Ni_{0.19}Co_{0.1}Na_{0.1}Y_{0.01}O₂. According to some embodiments, the material comprises Li_{1.07}Mn_{0.5172}Ni_{0.1952}Co_{0.0976}Na_{0.1}Y_{0.02}O₂. According to some embodiments, the material comprises Li_{1.07}Na_{0.1}Mn_{0.52}Y_{0.01}Ni_{0.2}Co_{0.1}O₂.

According to some embodiments of the invention, a composition and method for improving capacity and/or coulombic efficiency of lithium-rich layered oxide materials is presented herein. A method for making the composition and methods for making and using a battery including the composition are included.

According to some embodiments of the invention, an electrode includes a doped material formed by co-precipitation or solid-state synthesis.

### BRIEF DESCRIPTION OF SEVERAL VIEWS OF THE DRAWINGS

FIGS. 1A and 1B illustrate structural characterization by x-ray diffraction of certain embodiments disclosed herein and certain control materials.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to the range of values approximately near the given value in order to account for typical tolerance levels, measurement precision, or other variability of the embodiments described herein.

The term “transition metal” refers to a chemical element in groups 3 through 12 of the periodic table, including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), and meitnerium (Mt).

The term “pnictogen” refers to to any of the chemical elements in group 15 of the periodic table, including nitrogen (N), phosphorus (P), arsenic (As), antimony (Sb), and bismuth (Bi).

The term “alkali metal” refers to any of the chemical elements in group 1 of the periodic table, including lithium (Li), sodium (Na), potassium (K), rubidium (Rb), cesium (Cs), and francium (Fr).

The term “alkaline earth metals” to any of the chemical elements beryllium (Be), magnesium (Mg), calcium (Ca), strontium (Sr), barium (Ba), and radium (Ra).

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

The term “OLO” refers to an over-lithiated oxide material. The general formula for OLO materials is represented by Formula (i) above.

The term “over-lithiated NMC” refers to materials of Formula (i) in which nickel, manganese, and cobalt are present (that is, i, j, and k are all non-zero). The material represented by Formula (i) is an over-lithiated NMC. Over-lithiated NMC materials are thus a subgroup of OLO materials.

To the extent certain battery characteristics can vary with temperature, such characteristics are specified at room temperature (about 25-30 degrees C.), unless the context clearly dictates otherwise.

Ranges presented herein are inclusive of their endpoints. Thus, for example, the range 1 to 3 includes the values 1 and 3 as well as intermediate values.

In certain embodiments, an OLO material is formed in which lithium sites and transition metal sites are each doped with a different dopant. The dopants can be selected from transition metals, pnictogens, alkali metals, alkaline earth metals, and combinations thereof. The doping site can be a transition metal site, a lithium site, and/or an oxygen site in either phase of the OLO material. The doped materials disclosed herein can be used to form electrodes for lithium ion batteries that demonstrate improvements in capacity and coulombic efficiency as compared to batteries with electrodes formed from undoped OLO materials.

Preferred transition metals include, but are not limited to, yttrium, zirconium, and osmium. Preferred pnictogens, include, but are not limited to, antimony, nitrogen and phosphorus. Preferred alkali metals, include, but are not limited to, sodium. Preferred alkaline earth metals include, but are not limited to, barium.

The doped OLO active materials can be prepared by suitable synthetic methods, including co-precipitation (including solution co-precipitation), solid-state synthesis, and the like. Non-limiting examples of synthetic methods are presented herein. Several embodiments disclosed herein prepared using solution co-precipitation.

The structure of OLO materials is complicate and is not well understood, but in general their structure can be thought of as a composite or a solid solution. In an over-lithiated NMC, the components of the composite or solid solution are a monoclinic phase and a layered oxide phase. One of the notable features of the doping of OLO materials as disclosed herein is the formation of a new phase and physical changes to the OLO layered structure. Typically, simply doping a material does not resulting in the phase changes and physical structural changes seen in certain embodiments of the doped OLO active material. Depending on the atomic radius and atomic mass of the dopant element, changes of structure unit cell and relative peak intensity of X-ray diffraction can be observed. And, doping typically does not cause obvious structural changes, such as the presence of new peaks in x-ray diffraction analysis. However, in certain embodiments disclosed herein, extra peaks are found in x-ray diffraction analysis after doping using sodium or yttrium.

Without being bound by particular theories or mechanisms of action, the phases changes and ordering of the OLO layers facilitates the improvements in capacity and coulombic efficiency found in lithium ion batteries containing doped materials according to embodiments disclosed herein. These inventive compositions improve the capacity and coulombic efficiency of OLO materials while retaining the other favorable performance and commercial attributes of OLO materials. The doping methods disclosed herein are, in particular, useful for improving over-lithiated NMC materials. The phase changes as demonstrated by the extra peaks in the X-ray diffraction may be changes to the OLO structure itself, the formation of additional phases, or a combination thereof. The structural changes may improve the structure stability and the additional phases may increase conductivity, both of which improve the capacity and coulombic efficiency.

One exemplary embodiment is an OLO active material that has been doped with sodium and yttrium. This active material is prepared by a solution co-precipitation synthesis method and results in a layered oxide material that shows improved electrochemical performance, particularly with respect to capacity and columbic efficiency.

As is demonstrated by the data presented below, the double doping with sodium and yttrium was necessary to achieve the electrochemical performance improvements. Notably, the electrochemical performance improvements due to the double doping are much larger than any improvements from the any single doping. That is, the performance improvements are not additive, cumulative, or incremental, but rather synergistic and unexpected. As demonstrated below in the non-limiting example of sodium and yttrium, doping an OLO material with sodium resulted in modest improvements, while doping an OLO material with yttrium resulted in almost no improvement. Yet, the double doping with sodium and yttrium results in surprising improvement in the electrochemical properties of the lithium ion batteries containing these doped OLO materials.

The doped OLO material in a preferred embodiment can include a phase having a composition according to Formula (ii):

Li₁₊ₓ₋ₐD1ₐMn_{1-x-y-z-b1}Ni_{y-b2}D2_{b}Co_{z-b3}O₂₋₆₇ (ii)

where 0<a≦0.2, 0<b≦0.2, b1+b2+b3=b, 0.1≦x≦0.5, 0≦y<1, 0≦z≦0.5, and 0≦δ≦0.3. Preferably, 0<a≦0.1, 0<b≦0.1, 0.1≦x≦0.3, 0≦y<0.5, 0≦z≦0.3, and 0≦δ≦0.1. In the preferred embodiment, D1 comprises sodium and D2 comprises yttrium. However, more generally D1 can comprise alkali metals or alkaline earth metals. Also more generally, D2 can comprise transition metals or pnictogens. The double doped OLO materials disclosed herein can comprise the various combinations of the alternatives of D1 and D2 set forth above—alkali metals and transition metals; alkali metals and pnictogens; alkaline earth metals and transition metals; or alkaline earth metals and pnictogens.

The active materials can include a monoclinic phase of a material represented by Li₂MnO₃ and a layered oxide phase. Both phases further can include one or more dopants at the transition metal sites or the lithium sites.

Other exemplary embodiments include an OLO active material that has been doped with sodium and/or nitrogen and an OLO active material that has been doped with sodium and/or phosphorus. These active materials are prepared by solution co-precipitation or solid state synthesis methods.

The doped OLO material in a preferred embodiment can include a phase having a composition according to Formula (iii):

Li₁₊ₓ₋ₐD1ₐMn_{1-x-y-z}Ni_{y}Co_{z}O_{2-b}D2_{b} (iii)

where 0<a<0.2, 0<b≦0.1, 0.1≦x≦0.5, 0≦y<1, and 0≦z≦0.5. Preferably, 0<a≦0.1, 0<b≦0.05, 0.1≦x≦0.3, 0≦y<0.5, 0≦z≦0.3. In the preferred embodiment, D1 comprises sodium and D2 comprises nitrogen or phosphorus. However, more generally D1 can comprise alkali metals or alkaline earth metals. Also more generally, D2 can comprise pnictogens. The double doped OLO materials disclosed herein can comprise the various combinations of the alternatives of D1 and D2 set forth above—alkali metals and pnictogens as well as alkaline earth metals and pnictogens.

The active materials can include a monoclinic phase of a material represented by Li2MnO3 and a layered oxide phase. Both phases further can include one or more dopants at the oxygen sites or the lithium sites.

Still other exemplary embodiments include an OLO active material that has been doped with yttrium and/or nitrogen and an OLO active material that has been doped with yttrium and/or phosphorus. These active materials are prepared by solution co-precipitation or solid state synthesis methods.

The doped OLO material in a preferred embodiment can include a phase having a composition according to Formula (iv):

Li₁₊ₓMn_{1-x-y-z-a1}Ni_{y-a2}D1ₐCo_{z-a3}O_{2-b}D2_{b} (iv)

where 0<a≦0.2, a1+a2+a3=a, 0<b≦0.1, 0.1≦x≦0.5, 0≦y<1, and 0≦z≦0.5. Preferably, 0<a≦0.1, a1+a2+a3=a, 0<b≦0.05, 0.1≦x≦0.3, 0≦y<1, and 0≦z≦0.3. In the preferred embodiment, D1 comprises yttrium and D2 comprises nitrogen or phosphorus. However, more generally D1 can comprise transition metals. Also more generally, D2 can comprise pnictogens.

The active materials can include a monoclinic phase of a material represented by Li₂MnO₃ and a layered oxide phase. Both phases further can include one or more dopants at the oxygen sites or the transition metal sites.

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### EXAMPLES

Materials and Synthetic Methods. The lithium rich layered oxide material is prepared via a solution co-precipitation process combined with high temperature solid state reaction. Metal nitrates are used as Li, Mn, Ni, Co, Na and Y precursors. (NH₄)₂HPO₄ and LiN₃ are precursors used for N and P doping respectively. The as-received precursors from commercial sources are dissolved in deioninzed water and the stoichiometric metal nitrate solutions are first mixed together for the target composition, then NH4HCO3 solution is added slowly to the mixed metal nitrate solution to induce co-precipitation. After mixing for about 0.5 hours, the solutions are dried at 60 degrees C. overnight. After drying, the material is heated at 200 degrees C. for 3 hours and annealed at 900 degrees C. for 10 hours. Both drying and annealing processes are performed under air atmosphere. Na and Y metal powder can also be used as doping sources, as opposed to the metal nitrates.

Electrode Formulation. Cathodes based on the activated layered oxide material were prepared using a formulation composition of 80: 10: 10 (active material: binder: conductive additive) according to the following formulation method. 198 mg PVDF (Sigma Aldrich) was dissolved in 11 mL NMP (Sigma Aldrich) overnight. 198 mg of conductive additive was added to the solution and allowed to stir for several hours. 144 mg of the activated layered oxide material was then added to 1 mL of this solution and stirred overnight. Films were cast by dropping about 50 μL of slurry onto stainless steel current collectors and drying at 150 degrees C. for about 1 hour. Dried films were allowed to cool, and were then pressed at 1 ton/cm². Electrodes were further dried at 150 degrees C. under vacuum for 12 hours before being brought into a glove box for battery assembly.

Electrochemical Characterization. Electrodes and cells were electrochemically characterized at 30 degrees C. with a constant current C/10 charge and discharge rate between 4.8 and 2.0 V for the first two cycles. Starting from cycle 4, both the charge and the discharge rate are C/2 with a slow rate of C/10 on every twenty-fifth cycle between 4.8 and 2 V.

### RESULTS

Table 1 shows the results of first cycle discharge capacity and coulombic efficiency testing for certain materials. The materials in Table 1 include an undoped control over-lithiated NMC material (Li_{1.17}Mn_{0.53}Ni_{0.2}Co_{0.1}O₂). Table 1 also includes a doped over-lithiated NMC material (Li_{1.17}Mn_{0.51}Y_{0.02}Ni_{0.2}Co_{0.1}O₂), where the dopant is at a transition metal site. In this case, the transition metal site is the Mn site and the dopant is Y. Table 1 also includes a doped over-lithiated NMC material (Li_{1.07}Na_{0.1}Mn_{0.53}Ni_{0.2}Co_{0.1}O₂), where the dopant is at the lithium site and the dopant is Na.

Table 1 presents the results of several embodiments of double doped over-lithiated NMC materials where the dopants are alkali metals, alkaline earth metals, transition metals, and/or pnictogens, including sodium, barium, yttrium, scandium, zirconium, osmium, and antimony. Among the most improved materials are those doped with sodium and yttrium. For example, Li_{1.07}Mn_{0.52}Ni_{0.2}Co_{0.1}Na_{0.1}Y_{0.01}O₂; Li_{0.07}Mn_{1.07}Mn_{0.52}Ni_{0.19}Co_{0.1}Na_{0.1}Y_{0.02}O₂; Li_{1.07}Mn_{0.53}Ni_{0.19}Co_{0.1}Na_{0.1}Y_{0.01}O₂; Li_{1.07}Mn_{0.5172}Ni_{0.1952}Co_{0.0976}Na_{0.1}Y_{0.02}O₂; and Li_{1.07}Na_{0.1}Mn_{0.52}Y_{0.01}Ni_{0.01}Co_{0.1}O₂ all demonstrated improvements in capacity as compared to the control materials and the single doped materials.

Other improved materials include certain materials doped with sodium in the lithium site and alternative transition metals in both the lithium sites, such as Li_{1.07}Mn_{0.5236}Ni_{0.1976}Co_{0.0988}Na_{0.01}Zr_{0.01}O₂ and Li_{1.07}Mn_{0.5236}Ni_{0.1976}Co_{0.0988}Na_{0.1}Os_{0.01}O₂.

TABLE 1
Data for a conventional OLO compared to doped OLOs

| | | Cou- |
|---|---|---|
| | Ca- | lombic |
| | pacity | Effi- |
| | (mAh/ | ciency |
| Compounds | g) | (%) |
| Li_{1.17}Mn_{0.53}Ni_{0.2}Co_{0.1}O₂ | 262.8 | 89.1 |
| Li_{1.17}Mn_{0.5172}Ni_{0.1952}Co_{0.0976}Y_{0.02}O₂ | 263.9 | 85.4 |
| Li_{1.07}Mn_{0.53}Ni_{0.2}Co_{0.1}Na_{0.1}O₂ | 272.0 | 89.5 |
| Li_{1.07}Mn_{0.51}Ni_{0.2}Co_{0.1}Na_{0.1}Y_{0.02}O₂ | 265.2 | 87.4 |
| Li_{1.07}Mn_{0.52}Ni_{0.2}Co_{0.1}Na_{0.1}Y_{0.01}O₂ | 278.9 | 89.5 |
| Li_{1.07}Mn_{0.52}Ni_{0.2}Co_{0.09}Na_{0.1}Y_{0.02}O₂ | 261.6 | 89.5 |
| Li_{1.07}Mn_{0.52}Ni_{0.19}Co_{0.1}Na_{0.1}Y_{0.02}O₂ | 279.8 | 89.5 |
| Li_{1.07}Mn_{0.52}Ni_{0.19}Co_{0.09}Na_{0.1}Y_{0.03}O₂ | 265.1 | 90.2 |
| Li_{1.07}Mn_{0.53}Ni_{0.2}Co_{0.08}Na_{0.1}Y_{0.02}O₂ | 259.7 | 89.5 |
| Li_{1.07}Mn_{0.53}Ni_{0.2}Co_{0.09}Na_{0.1}Y_{0.01}O₂ | 265.3 | 89.5 |
| Li_{1.07}Mn_{0.53}Ni_{0.18}Co_{0.1}Na_{0.1}Y_{0.02}O₂ | 276.4 | 89.5 |
| Li_{1.07}Mn_{0.53}Ni_{0.19}Co_{0.1}Na_{0.1}Y_{0.01}O₂ | 279.0 | 89.5 |
| Li_{1.07}Mn_{0.53}Ni_{0.19}Co_{0.09}Na_{0.1}Y_{0.02}O₂ | 263.1 | 89.5 |
| Li_{1.07}Mn_{0.4981}Ni_{0.188}Co_{0.094}Na_{0.1}Y_{0.05}O₂ | 262.7 | 87.5 |
| Li_{1.07}Mn_{0.5186}Ni_{0.1957}Co_{0.0978}Na_{0.1}Y_{0.02}O₂ | 272.3 | 87.4 |
| Li_{1.07}Mn_{0.5172}Ni_{0.1952}Co_{0.0976}Na_{0.1}Y_{0.02}O₂ | 281.2 | 87.4 |
| Li_{1.07}Na_{0.1}Mn_{0.5186}Ni_{0.1957}Co_{0.0978}Y_{0.02}O₂ | 266.1 | 89.5 |
| Li_{1.12}Mn_{0.518}Ni_{0.1955}Co_{0.0977}Na_{0.05}Y_{0.02}O₂ | 274.7 | 89.5 |
| Li_{1.07}Mn_{0.5236}Ni_{0.1976}Co_{0.0988}Na_{0.1}Y_{0.01}O₂ | 272.8 | 91.0 |
| Li_{1.12}Mn_{0.5172}Ni_{0.1952}Co_{0.0976}Y_{0.02}Na_{0.05}O₂ | 266.9 | 89.5 |
| Li_{1.07}Mn_{0.5243}Ni_{0.1978}Co_{0.0989}Na_{0.1}Y_{0.01}O₂ | 275.7 | 91.0 |
| Li_{1.07}Na_{0.1}Mn_{0.52}Y_{0.01}Ni_{0.2}Co_{0.1}O₂ | 278.1 | 89.5 |
| Li_{1.07}Na_{0.1}Mn_{0.52}Y_{0.02}Ni_{0.19}Co_{0.1}O₂ | 269.3 | 89.5 |
| Li_{1.07}Mn_{0.5172}Ni_{0.1952}Co_{0.0976}Y_{0.02}Na_{0.1}O₂ | 265.9 | 87.4 |
| Li_{1.15}Mn_{0.5172}Ni_{0.1952}Co_{0.0976}Y_{0.02}Na_{0.02}O₂ | 276.0 | 89.5 |
| Li_{1.15}Mn_{0.5175}Ni_{0.1953}Co_{0.0976}Na_{0.02}Y_{0.02}O₂ | 263.8 | 89.5 |
| Li_{1.16}Mn_{0.5172}Ni_{0.1952}Co_{0.0976}Y_{0.02}Na_{0.01}O₂ | 271.5 | 89.5 |
| Li_{1.07}Mn_{0.5236}Ni_{0.1976}Co_{0.0988}Na_{0.1}Sb_{0.01}O₂ | 261.0 | 87.4 |
| Li_{1.07}Mn_{0.5236}Ni_{0.1976}Co_{0.0988}Na_{0.1}Sc_{0.01}O₂ | 276.1 | 85.5 |
| Li_{1.07}Mn_{0.5236}Ni_{0.1976}Co_{0.0988}Na_{0.1}Zr_{0.01}O₂ | 286.2 | 91.0 |
| Li_{1.07}Na_{0.1}Mn_{0.53}Zr_{0.01}Ni_{0.19}Co_{0.1}O₂ | 265.0 | 89.5 |
| Li_{1.07}Mn_{0.4981}Ni_{0.188}Co_{0.094}Na_{0.1}Os_{0.05}O₂ | 276.5 | 89.2 |
| Li_{1.07}Mn_{0.5172}Ni_{0.1952}Co_{0.0976}Na_{0.1}Os_{0.02}O₂ | 278.6 | 90.4 |
| Li_{1.07}Mn_{0.5236}Ni_{0.1976}Co_{0.0988}Na_{0.1}Os_{0.01}O₂ | 280.2 | 87.4 |
| Li_{1.07}Mn_{0.5236}Ni_{0.1976}Co_{0.0988}Na_{0.01}Os_{0.10}O₂ | 272.0 | 87.4 |
| Li_{1.07}Na_{0.1}Mn_{0.53}Os_{0.01}Ni_{0.19}Co_{0.1}O₂ | 276.3 | 89.5 |
| Li_{1.12}Mn_{0.5172}Ni_{0.1952}Co_{0.0976}Y_{0.02}Ba_{0.05}O₂ | 265.6 | 89.5 |
| Li_{1.15}Mn_{0.5172}Ni_{0.1952}Co_{0.0976}Y_{0.02}Ba_{0.02}O₂ | 261.2 | 89.5 |
| Li_{1.16}Mn_{0.5172}Ni_{0.1952}Co_{0.0976}Y_{0.02}Ba_{0.01}O₂ | 267.4 | 89.5 |

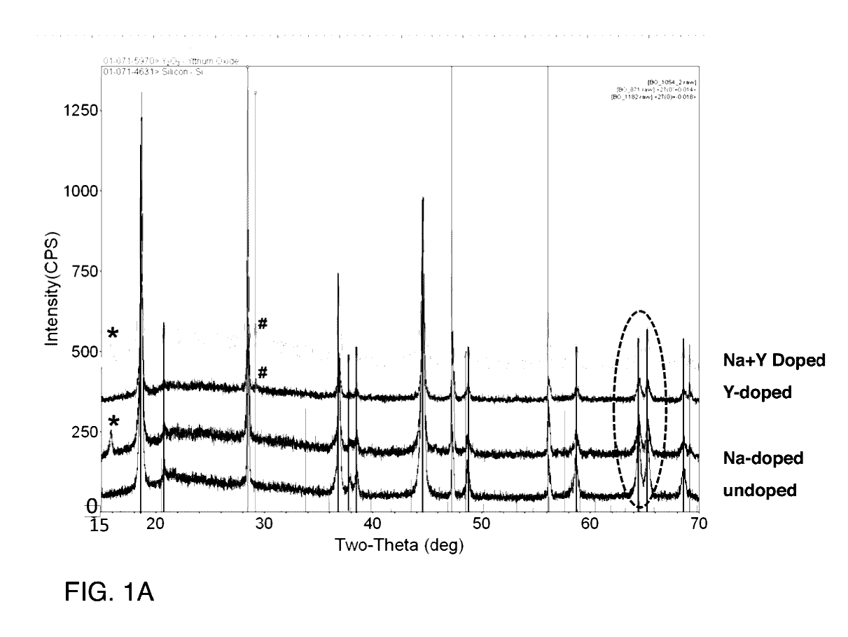

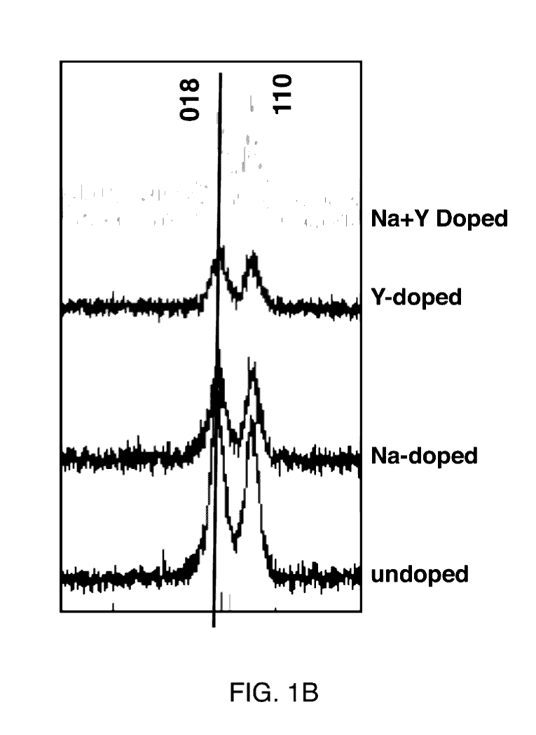

FIG. 1A illustrates characterization of the crystal structure of various materials using x-ray diffraction. The materials in FIG. 1A include an undoped control over-lithiated NMC material (Li_{1.17}Mn_{0.53}Ni_{0.2}Co_{0.1}O₂), a Y-doped over-lithiated NMC material (Li_{1.17}Mn_{0.51}Y_{0.02}Ni_{0.2}Co_{0.1}O₂), a Na-doped over-lithiated NMC material (Li_{1.07}Na_{0.1}Mn_{0.53}Ni_{0.2}Co_{0.1}O₂), and an over-lithiated NMC material doped with both Y and Na (Li_{1.07}Na_{0.1}Mn_{0.52}Ni_{0.19}Co_{0.1}Y_{0.02}O₂).

FIG. 1A identifies certain peaks of interest in the diffraction pattern. For example, the “star” symbol (*) identifies a peak at around 15.8 degrees 2-theta. This peak is associated with the use of a sodium nitrate (NaNO₃) precursor as the peak is found in both the sodium doped and the double doped material. The “hash” symbol (#) identifies a peak at around 28.6 degrees 2-theta. This peak is associated with the addition of Y(NO₃)₃ to OLO via doping. Thus, in this disclosure it has been identified that these two peaks reflect the presence of new phases in the doped material that occur when Y(NO₃)₃ and NaNO₃ were added in the synthesis of the OLO material (i.e., doping). It is believed that the peak at around 15.8 degrees 2-theta is associated with the compound Na_{0.7}Mn_{2.05} and the peak at around 28.6 degrees 2-theta is associated with the compound Y₂O₃.

FIG. 1B illustrates a close-up view of one portion of the x-ray diffraction patterns of FIG. 1A in which the relative intensity of peaks corresponding to the [018] and [110] lattice planes in the crystal structures of the four compounds is shown. The peaks labeled as such. No clear peak shifting in these lattice planes is observed due to doping of Na, or Y, or both. However, the relative peak intensity of [018] and [110] changes with double doping of Na and Y. Notably, these changes in the relative intensity of these two peaks occur to a lesser degree with single doping. The separation of those peaks is indicative of a layered characteristic in the OLO and the clear splitting of the two peaks indicates a well-organized layered structure of OLO.

Table 2 presents the data of FIG. 1B:

TABLE 2
Structural comparison of selected
doped and undoped materials

| | Ratio of |
|---|---|
| | (018)/ |
| Compounds | (110) |
| Li_{1.17}Mn_{0.53}Ni_{0.2}Co_{0.1}O₂ | 1.2 |
| Li_{1.17}Mn_{0.51}Y_{0.02}Ni_{0.2}Co_{0.1}O₂ | 1.02 |
| Li_{1.07}Na_{0.1}Mn_{0.53}Ni_{0.2}Co_{0.1}O₂ | 1.02 |
| Li_{1.07}Na_{0.1}Mn_{0.52}Ni_{0.19}Co_{0.1}Y_{0.02}O₂ | 0.9 |

Table 3 presents the results of electrochemical testing of lithium ion batteries containing electrodes formed from various embodiments of double doped over-lithiated NMC materials where the dopants are alkali metals and/or pnictogens, including sodium, nitrogen and phosphorus. For comparison, some over lithiated materials were doped with halogens, such as fluorine or chlorine. Li_{1.7}Mn_{0.53}Ni_{0.2}Co_{0.1}Na_{0.1}P_{0.2}O_{1.98}; Li_{1.17}Mn_{0.53}Ni_{0.2}Co_{0.1}Na_{0.1}N_{0.05}O_{1.95}; Li_{1.17}Mn_{0.53}Ni_{0.2}Co_{0.1}Na_{0.1}N_{0.02}O_{1.98}; and Li_{1.17}Mn_{0.53}Ni_{0.2}Co_{0.1}Na_{0.1}N_{0.01}O_{1.99} all demonstrated improvements in coulombic efficiency as compared to the control materials and the single doped materials. In this case, the doping was into the lithium and/or oxygen sites of the over-lithiated NMC materials.

TABLE 3
Performance of materials doped
on lithium and oxygen sites

| | Ca- | Coulombic |
|---|---|---|
| | pacity | Efficiency |
| Compounds | (mAh/g) | (%) |
| Li_{1.17}Mn_{0.53}Ni_{0.2}Co_{0.1}P_{0.05}O_{1.95} | 209.2 | 85.5 |
| Li_{1.17}Mn_{0.53}Ni_{0.2}Co_{0.1}P_{0.02}O_{1.98} | 263.5 | 89.9 |
| Li_{1.17}Mn_{0.53}Ni_{0.2}Co_{0.1}P_{0.01}O_{1.99} | 278.8 | 90.0 |
| Li_{1.17}Mn_{0.53}Ni_{0.2}Co_{0.1}Na_{0.1}P_{0.05}O_{1.95} | 246.1 | 88.4 |
| Li_{1.17}Mn_{0.53}Ni_{0.2}Co_{0.1}Na_{0.1}P_{0.02}O_{1.98} | 240.3 | 91.6 |
| Li_{1.17}Mn_{0.53}Ni_{0.2}Co_{0.1}Na_{0.1}N_{0.05}O_{1.95} | 266.7 | 90.9 |
| Li_{1.17}Mn_{0.53}Ni_{0.2}Co_{0.1}Na_{0.1}N_{0.02}O_{1.98} | 267.5 | 91.1 |
| Li_{1.17}Mn_{0.53}Ni_{0.2}Co_{0.1}Na_{0.1}N_{0.01}O_{1.99} | 268.2 | 91.1 |
| Li_{1.17}Mn_{0.53}Ni_{0.2}Co_{0.1}N_{0.05}O_{1.95} | 273.3 | 85.7 |
| Li_{1.17}Mn_{0.53}Ni_{0.2}Co_{0.1}N_{0.03}O_{1.95} | 261.3 | 85.4 |
| Li_{1.17}Mn_{0.53}Ni_{0.2}Co_{0.1}N_{0.02}O_{1.98} | 259.8 | 86.4 |
| Li_{1.17}Mn_{0.53}Ni_{0.2}Co_{0.1}N_{0.01}O_{1.99} | 263.3 | 84.2 |
| Li_{1.17}Mn_{0.53}Ni_{0.2}Co_{0.1}F_{0.05}O_{1.95} | 241.6 | 81.9 |
| Li_{1.17}Mn_{0.53}Ni_{0.2}Co_{0.1}F_{0.02}O_{1.98} | 260.4 | 85.0 |
| Li_{1.17}Mn_{0.53}Ni_{0.2}Co_{0.1}F_{0.01}O_{1.99} | 263.2 | 84.9 |
| Li_{1.17}Mn_{0.53}Ni_{0.2}Co_{0.1}Cl_{0.05}O_{1.95} | 270.3 | 86.6 |
| Li_{1.17}Mn_{0.53}Ni_{0.2}Co_{0.1}Cl_{0.02}O_{1.98} | 260.5 | 84.7 |
| Li_{1.17}Mn_{0.53}Ni_{0.2}Co_{0.1}Cl_{0.01}O_{1.99} | 270.8 | 87.4 |
| Li_{1.17}Mn_{0.53}Ni_{0.2}Co_{0.1}O₂ | 261.8 | 89.5 |

Table 4 presents the results of electrochemical testing of lithium ion batteries containing electrodes formed from various embodiments of double doped over-lithiated NMC materials where the dopants are transition metals and/or pnictogens, including yttrium, nitrogen and phosphorus. Li_{1.17}Mn_{0.53}Ni_{0.2}Co_{0.1}Y_{0.02}N_{0.02}O_{1.98} and Li_{1.17}Mn_{0.53}Ni_{0.2}Co_{0.1}Y_{0.02}N_{0.01}O_{1.99} both demonstrated improvements in capacity as compared to the control materials and the single doped materials. In this case, the doping was into the transition metal and/or oxygen sites of the over-lithiated NMC materials.

TABLE 4
Performance of materials doped on
transition metal and oxygen sites

| | | Coulombic |
|---|---|---|
| | Capacity | Efficiency |
| Compounds | (mAh/g) | (%) |
| Li_{1.17}Mn_{0.53}Ni_{0.2}Co_{0.1}Y_{0.02}P_{0.01}O_{1.99} | 255.5 | 86.2 |
| Li_{1.17}Mn_{0.53}Ni_{0.2}Co_{0.1}Y_{0.02}N_{0.05}O_{1.95} | 265.3 | 85.6 |
| Li_{1.17}Mn_{0.53}Ni_{0.2}Co_{0.1}Y_{0.02}N_{0.02}O_{1.98} | 267.2 | 86.4 |
| Li_{1.17}Mn_{0.53}Ni_{0.2}Co_{0.1}Y_{0.02}N_{0.01}O_{1.99} | 267.9 | 86.6 |
| Li_{1.17}Mn_{0.5172}Ni_{0.1952}Co_{0.0976}Y_{0.02}O₂ | 263.9 | 87.5 |
| Li_{1.17}Mn_{0.53}Ni_{0.2}Co_{0.102} | 261.8 | 89.5 |

As compared to the prior art, certain embodiments disclosed herein demonstrate a synergistic effect from doping different and specific dopants at different atomic sites. The data disclosed herein demonstrate that it is difficult to predict which dopants in which sites will provide this synergistic effect. And, no synergistic effect has been demonstrated in the patents and publications discussed in the background herein.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. An electrode, comprising:
a material represented by
Li₁₊ₓ₋ₐD1ₐMn_{1-x-y-z-b1}Ni_{y-b2}D2_{b}Co_{z-b3}O_{2-δ}
where0<a≦0.2,0<b≦0.2,b1+b2+b3=b,0.1≦x≦0.5,0≦y<1,0≦z≦0.5,and0 ≦δ≦0.3.
wherein D1 comprises sodium (Na) and D2 comprises yttrium (Y).

2. The electrode of claim 1 wherein 0<a≦0.1.

3. The electrode of claim 1 wherein 0.05≦a≦0.1.

4. The electrode of claim 1 wherein 0<b≦0.1.

5. The electrode of claim 1 wherein the material comprises Li_{1.07}Mn_{0.52}Ni_{0.2}Co_{0.1}Na_{0.1}Y_{0.01}O₂.

6. The electrode of claim 1 wherein the material comprises Li_{1.07}Mn_{0.52}Ni_{0.19}Co_{0.1}Na_{0.1}Y_{0.02}O₂.

7. The electrode of claim 1 wherein the material comprises Li_{1.07}Mn_{0.53}Ni_{0.19}Co_{0.1}Na_{0.1}Y_{0.01}O₂.

8. The electrode of claim 1 wherein the material comprises Li_{1.07}Mn_{0.5172}Ni_{0.1952}Co_{0.0976}Na_{0.1}Y_{0.02}O₂.

9. The electrode of claim 1 wherein the material comprises Li_{1.07}Na_{0.1}Mn_{0.52}Y_{0.01}Ni_{0.2}Co_{0.1}O₂.

10. The electrode of claim 1 wherein the material is formed by co-precipitation.

11. The electrode of claim 1 wherein the material is formed by solid-state synthesis.

12. A battery comprising the electrode of claim 1.
